(19) United States
(12) Patent Application Publication
(10) Pub. No.: US 2012/0019677 A1
(43) Pub. Date: Jan. 26, 2012

(54) IMAGE STABILIZATION IN A DIGITAL CAMERA

(75) Inventors: Ping Wah Wong, Sunnyvale, CA (US); Weihua Xiong, Cupertino, CA (US)

(73) Assignee: NETHRA IMAGING INC., Santa Clara, CA (US)

(21) Appl. No.: 12/843,746

(22) Filed: Jul. 26, 2010

(51) Int. Cl. H04N 5/228

(52) U.S. Cl. 348/208.4; 348/208.99; 348/E05.031

(57) ABSTRACT

Disclosed is a method for processing a digital image, the method comprising: selecting a set of frames from a plurality of frames captured by a digital imaging device: identifying a set of pixel blocks from the set of frames; and integrating the set of pixel blocks to process the digital image.

### TECHNICAL FIELD OF THE DISCLOSURE

The present disclosure generally relates to digital images, and more particularly to stabilization of digital images.

### BACKGROUND OF THE DISCLOSURE

A digital imaging device, such as a digital camera, may be used to capture a variety of scenes. An image of a scene captured by the digital camera may exhibit a degree of blurriness. The blurriness is reflected in the image due to unwanted motion present in the image. The unwanted motion present in the image is caused either by a movement in the scene or by a movement of the digital camera while a user is capturing the scene using the digital camera. Either or both of these movements cause motion artifacts and blurriness in the image. A process of removing the blurriness and motion artifacts from the image is termed as image stabilization.

The present disclosure provides a method and a system to produce stabilized images with reduced blurriness and motion artifacts.

### SUMMARY OF THE DISCLOSURE

In one aspect, the present disclosure provides a method for processing a digital image, the method comprising: selecting a set of frames from a plurality of frames captured by a digital imaging device; identifying a set of pixel blocks from the set of frames; and integrating the set of pixel blocks to process the digital image.

In another aspect, the present disclosure provides a digital imaging device having an image processor for processing a digital image, the image processor comprises: a frame selecting module capable of selecting a set of frames from a plurality of frames captured by a digital imaging device; an identifying module capable of identifying a set of pixel blocks from the set of frames; and an integrating module capable of integrating the set of pixel blocks to generate the digital image.

In yet another aspect of the present disclosure, the present disclosure provides computer-implemented methods, computer systems and a computer readable medium containing a computer program product for processing a digital image by an image processor, the computer program product comprising: program code for selecting a set of frames from a plurality of frames captured by a digital imaging device: program code for identifying a set of pixel blocks from the set of frames; and program code for integrating the set of pixel blocks to process the digital image.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 is a block diagram of a digital imaging device, in accordance with an embodiment of the invention;

FIG. 2 is a block diagram of an image buffer and an image processor used by the digital imaging device for stabilizing a digital image, in accordance with an embodiment of the present disclosure;

FIG. 3 is a pictorial representation of a method for stabilizing a digital image, in accordance with an embodiment of the present disclosure;

FIG. 4 is a pictorial representation of a method for stabilizing a digital image, in accordance with an embodiment of the present disclosure;

FIG. 5 is a flow chart representing a method for stabilizing a digital image, in accordance with an embodiment of the present disclosure; and

FIG. 6 is a flow chart representing a method for stabilizing a digital image, in accordance with an embodiment of the present disclosure.

The method and system have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Before describing in detail embodiments that are in accordance with the present disclosure, it should be observed that the embodiments reside primarily in combinations of method steps and system components related to processing a digital image.

As used herein, relational terms such as first and second, and the like may be used solely to distinguish one module or action from another module or action without necessarily requiring or implying any actual such relationship or order between such modules or actions. The terms “comprises,” “comprising,” or any other variation thereof are intended to cover a non-exclusive inclusion, such that a process, method, article, or apparatus that comprises a list of elements that does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

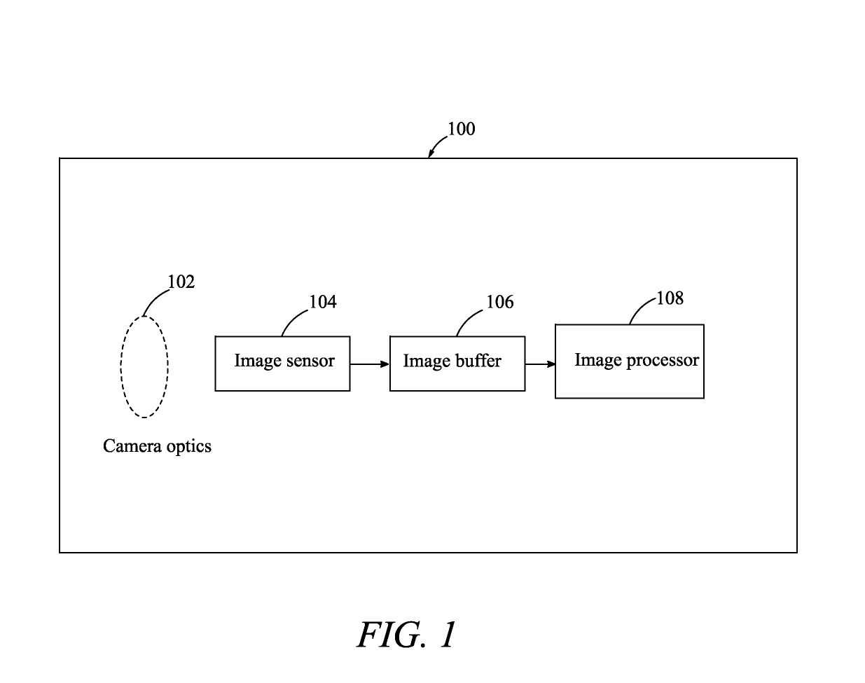

The present disclosure provides a method and a system for stabilizing a digital image. Specifically, the method and the system disclosed in the present disclosure reduce motion artifacts and blurriness from a digital image in a capture process in a digital camera. More specifically, in the capture process, a plurality of frames of a scene is captured by the digital camera and is integrated so as to aggregate sharpest pixel blocks of the plurality of frames. The integration of the plurality of frames results in a stabilized digital image which is free from motion artifacts and blurriness. Each frame of the plurality of frames is basically an image and is captured at a very short interval of the scene. In one embodiment, the digital camera may capture N frames of the scene in one second, where 2≦N≦16. In one embodiment of the present disclosure, the digital image is processed/generated/stabilized by selecting sharpest pixels blocks from the plurality of frames and subsequently integrating the sharpest pixels blocks to achieve the stabilized digital image, as will be explained in conjunction with FIGS. 1 to 6.

Referring to FIG. 1, a block diagram of a digital imaging device 100 is shown, in accordance with an embodiment of the present disclosure. In one embodiment, the digital imaging device 100 may be a digital camera. The digital imaging device 100 includes camera optics 102, an image sensor 104, an image buffer 106, and an image processor 108. The camera optics 102 and the image sensor 104 may enable the digital imaging device 100 to capture a digital image. The digital image may exhibit motion artifacts and blurriness. In order to remove motion artifacts and blurriness from the digital image, a plurality of frames may be captured and integrated by the digital imaging device 100 in the capture process. Further, each frame may comprise millions of pixels depending upon a resolution of the image sensor 104. However, for the sake of brevity of this description, a smaller pixel matrix of the frame is considered for explaining various embodiments of the present disclosure.

In one embodiment of the present disclosure, the plurality of frames captured by the digital imaging device 100 in one second may be N, where 2≦N≦16. The plurality of frames may be stored in the image buffer 106 which may be a memory device capable of storing a large amount of data. The image buffer 106 may be coupled to the image processor 108. The image processor 108 is capable of reading the plurality of frames from the image buffer 106 for processing the plurality of the frames. In one embodiment, the digital imaging device 100 may be in the form of the digital camera, in which case, the digital imaging device 100 may include other components dictated by functions of the digital camera.

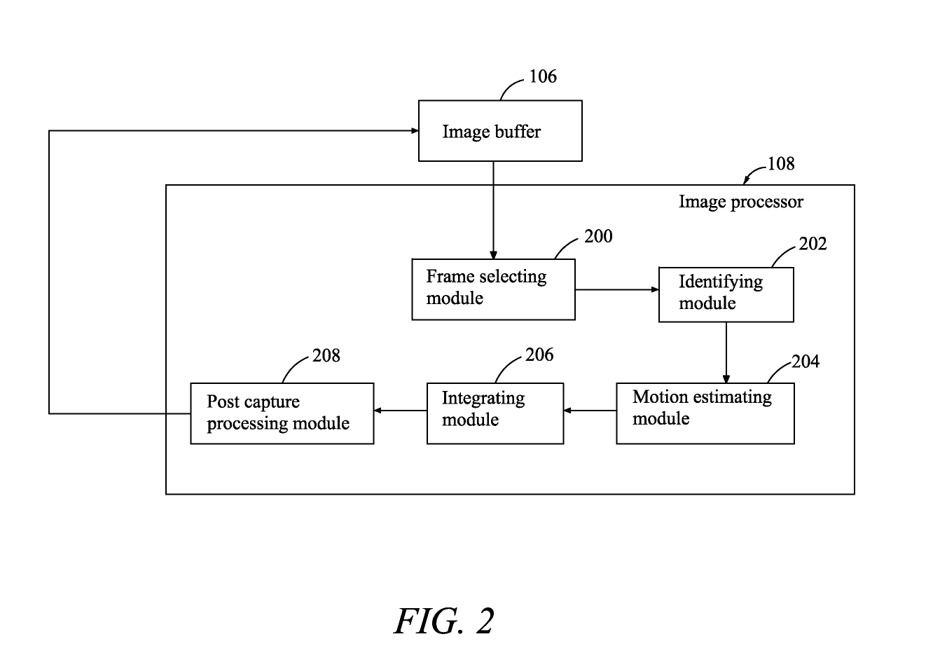

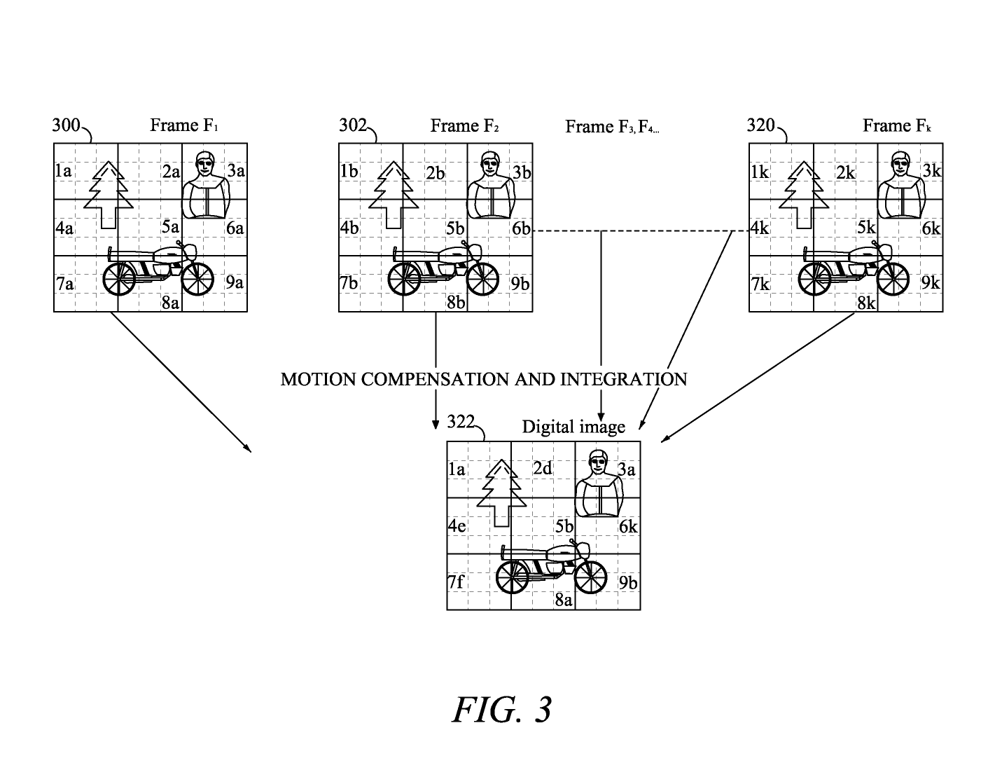

Referring now to FIGS. 2 and 3, the image processor 108 includes a frame selecting module 200, an identifying module 202, a motion estimating module 204, an integrating module 206, and a post capture processing module 208. At a top level, it is to be understood that the frame selecting module 200 may perform a frame selection operation to select a set of K best frames, such as frame F₁ to frame Fₖ as shown in FIG. 3, from a plurality of frames N stored in the image buffer 106, where K≦N. Out of the set of K best frames, a set of best pixel blocks is identified. Further, a motion analysis is performed by the motion estimating module 204 on the K best frames. Subsequently, the set of best pixel blocks is integrated into one integrated frame. The integrated frame is further post-processed by the post capture processing module 208 and then sent to an output. This is a final stabilized digital image.

At a more detailed level, it is to be understood that the frame selecting module 200 is capable of selecting a set of frames K from the plurality of frames N stored in the image buffer 106. The set of frames may include one or more frames. In one embodiment, the set of frames may include frames 300 to 320 as shown in FIG. 3. For the sake of brevity of this description, it is shown that each frame of the set of frames may be divided into nine pixel blocks as shown in FIG. 3. In typical systems, the number of blocks depends on the size of the image, and can be larger than 9. Further, it is shown that each pixel block may contain a plurality of pixels.

In one embodiment, each frame of the plurality of frames may be assigned a sharpness parameter. In a preferred embodiment, the sharpness parameter for each frame of the plurality of frames may be calculated by using a smoothed version of local gradient information. Specifically, the sharpness parameter for each frame may be calculated using the following equation:

$$sharpness = {\sum }_{m , n} {w}_{m , n} ( {\sum }_{i , j} {h}_{i , j} {x}_{m - i , n - j} )$$

where, h_{i,j} is an impulse response of a high pass filter for a pixel x_{m,n} of a frame, and w_{m,n} is a weight array. The term in parenthesis is a high pass version of the frame at pixel location (m, n) and hence reflects local sharpness or gradient information in the frame. The local gradient information is summed over the entire frame to give a sharpness parameter. The sum is weighted using a weight array so that it is possible to put emphasis in selected areas of the frame, e.g. putting higher emphasis on middle portions of the frame as compared to boundary portions.

Based on the sharpness parameter of each frame, the set of frames may be selected from the plurality of frames by the frame selecting module 200. Specifically, the frame selecting module 200 may select sharpest frames, which may constitute the set of frames, from the plurality of frames.

Subsequently, another sharpness parameter may be computed, using the method explained above, for each pixel block in each frame of the set of frames. Based on this sharpness parameter, the identifying module 202 may identify a set of pixel blocks from the set of frames. For example, the identifying module 202 may select a pixel block 1a from the frame F₁ when the pixel block 1a has a highest sharpness parameter among corresponding pixel blocks in remaining frames of the set of frames. Similarly, the identifying module 202 may select sharpest pixel blocks, which may constitute the set of pixel blocks, from the set of frames.

After the set of pixel blocks is identified, the motion estimating module 204 may calculate motion vectors on a block by block basis for the set of frames. Subsequently, the motion estimating module 204 may compensate a motion between the set of frames based on the motion vectors. In a preferred embodiment, the motion vectors are calculated for block size of 16×16 with a search range of plus minus 8 in each direction. The motion vector for a 16×16 pixel block may be calculated using the following equation:

Motion vector=Global coarse motion vector+Local fine motion vector

Global coarse motion vector may be calculated using N×N regions spread uniformly throughout a frame. Motion estimations for each of the N×N regions are performed over a relatively large search range to obtain N×N motion vectors, one for each region. Then a classification method is applied to detect outliers among the N×N motion vectors, and linear interpolation among the motions vectors that are not classified as outliers is used to adjust outlier motion vector values. The global coarse motion vector is then calculated as the average of the N×N motion vectors after processing the outlier motion vector values. In a preferred embodiment, N=7, and the search range is plus minus 32. Even though this is a relatively large search range, a number of blocks that this search will be performed on are 49, which is small compared to all the 16×16 blocks in the entire frame.

After the global coarse motion vector has been determined, the local fine motion vector for each 16×16 block in the frame is determined using the global coarse motion vector as an offset. In this embodiment, the search range for the local fine motion vector can be significantly reduced. In a preferred embodiment, the search range of plus minus 8 pixels is used for local fine motion vector estimation.

Having the motion vectors and sharpness parameters for each pixel block of the set of frames, the integrating module 206 may integrate the set of pixel blocks to generate a stabilized digital image 322 as shown in FIG. 3. One problem with this integration procedure is that placements of the set of pixel blocks may produce artifacts in the digital image 322 due to motion or discontinuity in pixel block boundaries. However, in the present disclosure, artifacts are avoided by adjusting the motion vectors by considering each pixel block with its vertical and horizontal pixel block neighbors in the pixel block boundaries and thereby compensating the motion. Specifically, the present disclosure employs three constraints to compensate motion and avoid artifacts. The three constraints are—epipolar line constraint, ordering constraint, and continuity constraint.

The epipolar line constraint means that all pixel blocks that share a same row should fall along a straight line at same angle after motion compensation. The ordering constraint means that if a pixel block m is on a left of a pixel block n before motion compensation, then a relative directional position of the two pixels blocks m and n should remain the same after motion compensation. The continuity constraint means that the motion vectors of neighboring pixel blocks should be smooth.

The motion vectors for each pixel block are stored in the frame and are then adjusted to maintain the three constraints; thereby compensating the motion and avoiding the artifacts. This may be done using an iterative procedure that is equivalent to low pass filtering the motion vectors so that a motion from block to block transitions smoothly and continuously.

Finally, the digital image 322 may be read by the post capture processing module 208 which uses a combination of two linear filters and a contrast mapping step (not shown). The two linear filters have a low pass and a high pass characteristic, respectively. Filtering of the digital image is controlled by an edge detector such as a Sobel edge detector. Using the edge information, non-edge pixels are low pass filtered whereas edge pixels are high pass filtered. This configuration serves to filter noise in the digital image as well as enhances the edges. The filtered result is put to a local contrast mapping step to enhance the local contrast. A pre-defined S-curve that is normalized to maximum and minimum pixels within each pixel neighborhood is used for mapping pixel data.

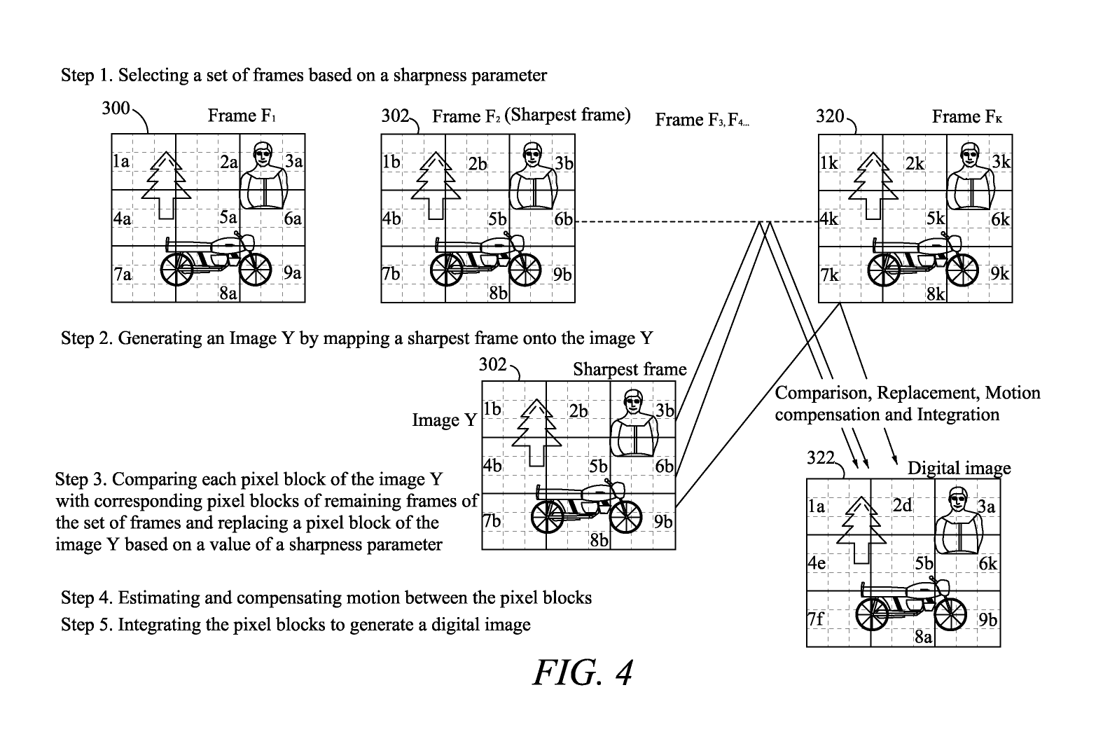

Referring now to FIG. 4, a pictorial representation of a method for processing the digital image 322 is shown, in accordance with an embodiment of the present disclosure is shown. In this embodiment, the frame selecting module 200 may perform the frame selection operation to select the set of K frames, such as F₁ to Fₖ, from the plurality of frames N stored in the image buffer 106, based on the sharpness parameter in a manner explained above. Further, the set of frames is ordered in a decreasing order of sharpness from left to right. Subsequently, a sharpest frame, such as a frame F₂ of the set of frames may be mapped onto an image Y, as shown on FIG. 4.

In one embodiment, after the sharpest frame F₂ is mapped onto the image Y, each pixel block of the image Y is compared with corresponding pixel blocks of remaining frames of the set of frames. If a sharpness parameter of a pixel block in the image Y is less than a sharpness parameter of a corresponding pixel block in a frame of the remaining frames, then the pixel block in the image Y is replaced by the corresponding pixel block of the frame. For example, the sharpness parameter of the first pixel block 1b of the image Y may be compared with the sharpness parameters of corresponding pixel blocks 1a, 1c, 1d, to 1k of frames F₁, F₃, F₄ to Fₖ, respectively. If the sharpness parameter of the pixel block 1b in the image Y is less than the sharpness parameter of any of the corresponding pixel blocks 1a, 1c, 1d, to 1k, then the pixel block 1b gets replaced in the image Y with the corresponding pixel block having a higher sharpness parameter. In this embodiment, the pixel block 1b is replaced by the corresponding pixel block 1a of frame F1 as the sharpness parameter of the corresponding pixel block 1a is higher than that of the pixel block 1b. Similarly, all the pixel blocks of the image Y are compared with corresponding pixel blocks of the remaining frames of the set of frames to generate a digital image 322 having sharpest pixel blocks of the set of frames.

In another embodiment of the present disclosure, after the sharpest frame is mapped onto the image Y, the sharpness parameter of each pixel block of the image Y is compared with corresponding pixel blocks of a next frame of the set of frames. A pixel block in the image Y is replaced by a corresponding pixel block of the next frame based on the sharpness parameter, to generate an improved image Y1 (not shown). Subsequently, each pixel block of the improved image Y1 is compared with a next frame to generate an improved image Y2 (not shown). This process may continue till the digital image 322 is generated having sharpest pixel blocks selected from the set of frames. To illustrate this with the help of an example, consider that the image Y and the frame F1 are integrated so as to generate an improved image Y1. Subsequently, the improved image Y1 is compared with frame F3 and same integration procedure is performed to generate an improved image Y2. This is continued until all the frames are considered on a block by block basis to generate the digital image 322.

Prior to integrating the image Y with the remaining frames, motion vectors are calculated on a block by block basis between the image Y and the remaining frames in a manner explained above. Further, the motion vectors are adjusted based on the dime constraints explained above to avoid artifacts. Furthermore, a motion between the image Y and the remaining frames is compensated based on the motion vectors to generate stabilized digital image 322.

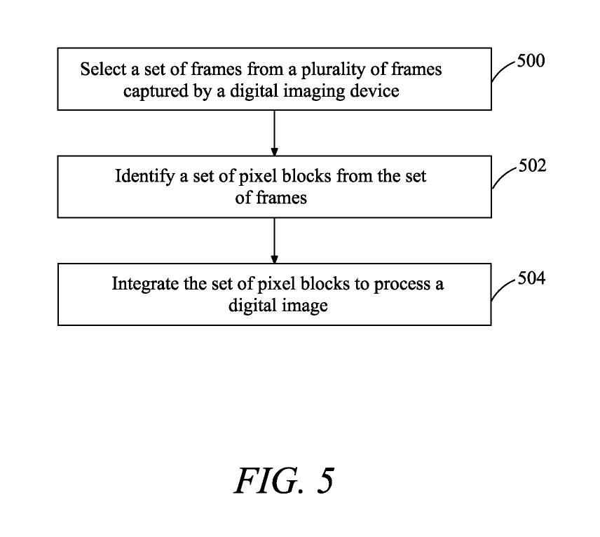

Referring now to FIG. 5, a flow chart representing a method for stabilizing a digital image is shown, in accordance with an embodiment of the present disclosure. Specifically, at 500 a set of frames is selected from a plurality of frames captured by a digital imaging device 100. At 502, a set of pixel blocks is identified from the set of frames. At 504, the set of pixel blocks is integrated to process the digital image.

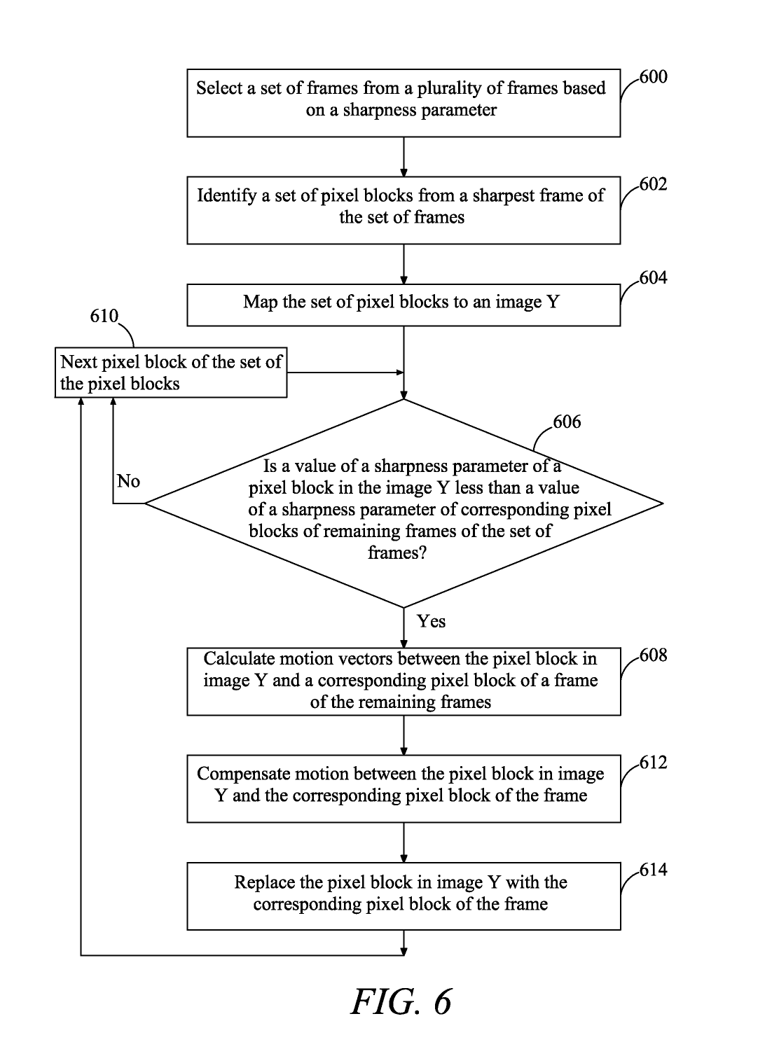

Referring now to FIG. 6, a flow chart representing a method for stabilizing a digital image is shown, in accordance with an embodiment of the present disclosure. Specifically, at 600 a set of frames is selected from a plurality of frames based on a sharpness parameter. At 602, a set of pixel blocks is identified from a sharpest frame of the set of frames. At 604, the set of pixel blocks is mapped onto an image Y. At 606, it is determined whether a value of a sharpness parameter of a pixel block in the image Y is less than a value of a sharpness parameter of corresponding pixel blocks of remaining frames of the set of frames. If no, then at 610 a next pixel block of the set of pixel blocks is fed to the step 606. If yes, then motion vectors between the pixel block in image Y and a corresponding pixel block of a frame of the remaining frames is calculated at 608. Further, at 612, motion between the pixel block in image Y and the corresponding pixel block of the frame is compensated. At 614, the pixel block in the image Y is replaced with the corresponding pixel block of the frame. The method then goes to block 610 and continues until all the frames are considered on a block by block basis to generate the digital image 322.

It will be appreciated that embodiments of the disclosure described herein may comprise one or more conventional processors and unique stored program instructions that control the one or more processors to implement, in conjunction with certain non-processor circuits, some, most, or all functions of processing a sensor data. Alternatively, some or all functions of processing a sensor data could be implemented by a state machine that has not stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As will be understood by those familiar with the art, the disclosure may be embodied in other specific forms without departing from the spirit or essential characteristics thereof. Likewise, the particular naming and division of the modules, agents, managers, functions, procedures, actions, methods, classes, objects, layers, features, attributes, methodologies and other aspects are not mandatory or significant, and the mechanisms that implement the disclosure or its features may have different names, divisions and/or formats. Furthermore, as will be apparent to one of ordinary skill in the relevant art, the modules, agents, managers, functions, procedures, actions, methods, classes, objects, layers, features, attributes, methodologies and other aspects of the disclosure can be implemented as software, hardware, firmware or any combination of the three. Of course, wherever a component of the present disclosure is implemented as software, the component can be implemented as a script, as a standalone program, as part of a larger program, as a plurality of separate scripts or programs, as a statically or dynamically linked library, as a kernel loadable module, as a device driver, and/or in every and any other way known now or in the future to those of skill in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the disclosure, which is set forth in the following claims.

I/We claim:

1. A method for processing a digital image, the method comprising:
selecting a set of frames from a plurality of frames captured by a digital imaging device;
identifying a set of pixel blocks from the set of frames; and
integrating the set of pixel blocks to process the digital image.

2. The method of claim 1, wherein the identifying comprises selecting the set of pixel blocks from a sharpest frame of the set of frames.

3. The method of claim 2, wherein the integrating comprises:
comparing a sharpness parameter of a pixel block of the set of pixel blocks in the digital image with a sharpness parameter of corresponding pixel blocks of remaining frames of the set of frames; and
replacing the pixel block in the digital image with a corresponding pixel block of a frame of the remaining frames when a value of the sharpness parameter of the pixel block in the digital image is less than a value of the sharpness parameter of the corresponding pixel block of the frame.

4. The method of claim 1, wherein the identifying comprises selecting the set of pixel blocks from the set of frames based on a sharpness parameter.

5. The method of claim 1, wherein the selecting comprises identifying the set of frames from the plurality of frames based on a sharpness parameter.

6. The method of claim 1, further comprising estimating motion between pixel blocks of the set of frames, the estimating motion comprises:
calculating motion vectors between the pixel blocks; and
compensating motion between the pixel blocks based on the motion vectors prior to integrating the set of pixel blocks.

7. The method of claim 6, wherein the calculating comprises determining a global coarse motion vector and a local fine motion vector.

8. A digital imaging device having an image processor for processing a digital image, the image processor comprises:
a frame selecting module capable of selecting a set of frames from a plurality of frames captured by a digital imaging device;
an identifying module capable of identifying a set of pixel blocks from the set of frames; and
an integrating module capable of integrating the set of pixel blocks to generate the digital image.

9. The image processor of claim 8, wherein the identifying module is capable of selecting the set of pixel blocks from a sharpest frame of the set of frames.

10. The image processor of claim 9, wherein the integrating module is capable of:
comparing a sharpness parameter of a pixel block of the set of pixel blocks in the digital image with a sharpness parameter of corresponding pixel blocks of remaining frames of the set of frames; and
replacing the pixel block in the digital image with a corresponding pixel block of a frame of the remaining frames when a value of the sharpness parameter of the pixel block in the digital image is less than a value of the sharpness parameter of the corresponding pixel block of the frame.

11. The image processor of claim 8, wherein the identifying module is capable of selecting the set of pixel blocks from the set of frames based on a sharpness parameter.

12. The image processor of claim 8, wherein the frame selecting module is capable of identifying the set of frames from the plurality of frames based on a sharpness parameter.

13. The image processor of claim 8, further comprises a motion estimating module capable of:
calculating motion vectors between a pair of pixel blocks of the set of pixel blocks; and
compensating motion between the pair of pixel blocks based on the motion vectors prior to integrating the set of pixel blocks.

14. The image processor of claim 13, wherein the calculating comprises determining a global coarse motion vector and a local fine motion vector.

15. A computer readable medium containing a computer program product for processing a digital image by an image processor, the computer program product comprising:
program code for selecting a set of frames from a plurality of frames captured by a digital imaging device;
program code for identifying a set of pixel blocks from the set of frames; and
program code for integrating the set of pixel blocks to process the digital image.

16. The computer program product of claim 15, wherein the program code for identifying comprises selecting the set of pixel blocks from a sharpest frame of the set of frames.

17. The computer program product of claim 16, wherein the program code for integrating comprises:
program code for comparing a sharpness parameter of a pixel block of the set of pixel blocks in the digital image with a sharpness parameter of corresponding pixel blocks of remaining frames of the set of frames; and
program code for replacing the pixel block in the digital image with a corresponding pixel block of a frame of the remaining frames when a value of the sharpness parameter of the pixel block in the digital image is less than a value of the sharpness parameter of the corresponding pixel block of the frame.

18. The computer program product of claim 15, wherein the program code for identifying comprises selecting the set of pixel blocks from the set of frames based on a sharpness parameter.

19. The computer program product of claim 15, wherein the program code for selecting comprises identifying the set of frames from the plurality of frames based on a sharpness parameter.

20. The computer program product of claim 15, further comprising program code for estimating motion between pixel blocks of the set of frames, the estimating motion comprises:
program code for calculating motion vectors between the pixel blocks; and
program code for compensating motion between the pixel blocks based on the motion vectors prior to integrating the set of pixel blocks.
